(19) United States
(12) Patent Application Publication
(10) Pub. No.: US 2007/0268442 A1
(43) Pub. Date: Nov. 22, 2007

(54) Display substrate and method of manufacturing the same and liquid crystal display apparatus having the same

(75) Inventors: Jeong-Min Oh, Seoul (KR); In-Sung Lee, Seoul (KR); Ho-Nam Yum, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/784,296

(22) Filed: Apr. 5, 2007

(30) Foreign Application Priority Data
May 19, 2006 (KR) 10-2006-0045021

(51) Int. Cl. G02F 1/1345

(52) U.S. Cl. 349/149

(57) ABSTRACT

A display substrate includes a plurality of gate wirings, a plurality of source wirings, a plurality of pixel portions, an electrical short pad part and a short element. The electrical short pad part is formed in a peripheral area surrounding the display area and formed from at least one of the gate metallic layer and the source metallic layer to receive a common voltage. The short element makes contact with the electrical short pad part and has electric conductivity. The electrical short pad part includes a first metallic layer and a second metallic layer in sequence, and the second metallic layer has greater ionization energy than the first metallic layer. The electrical short pad part is exposed onto the surface of the display substrate. Accordingly, an extra cover electrode for preventing the electrical short pad part from corrosion may be omitted, so that static electricity is prevented from being applied into the display substrate.

### CROSS-REFERENCE TO RELATED APPLICATIONS

This application relies for priority upon Korean Patent Application No. 10-2006-45021 filed on May 19, 2006, the contents of which are herein incorporated by reference in its entirety.

### BACKGROUND OF THE INVENTION

1. Field of the Invention

The present invention relates to a display substrate and a method of manufacturing the display substrate and a liquid crystal display apparatus having the display substrate. More particularly, the present invention relates to a display substrate and a method of manufacturing the display substrate and a liquid crystal display apparatus having the display substrate for decreasing defects.

2. Description of the Related Art

In general, a liquid crystal display (LCD) apparatus includes a pixel substrate, an opposite substrate opposite to the pixel substrate and a liquid crystal layer disposed between the pixel substrate and the opposite substrate. Liquid crystal molecules of the liquid crystal layer vary arrangement in response to an externally provided electric field, and light transmittance of the liquid crystal layer is changed to display an image.

The pixel substrate includes a display area having a plurality of pixel portions to display an image and a peripheral area surrounding the display area. The pixel portions are formed as a matrix shape by a plurality of gate wirings and a plurality of data wirings crossing the gate wirings. A thin film transistor electrically connected to each of the gate wirings and each of the data wirings and a pixel electrode electrically connected to the thin film transistor are formed in each of the pixel portions.

Static electricity is generated in a process for manufacturing the pixel substrate. The static electricity often flows into the inside of the pixel substrate through the cover electrode exposed onto the pixel substrate in the process for manufacturing the pixel substrate. The static electricity flowing into the pixel substrate causes a wiring defect such as a disconnection and a circuit short of the wirings and damages the thin film transistor, so that reliability of LCD apparatus is deteriorated.

### SUMMARY OF THE INVENTION

The present invention provides a display substrate capable of decreasing defects.

The present invention also provides a method for manufacturing the display substrate.

The present invention also provides an LCD apparatus having the display substrate.

In one aspect of the present invention, a display substrate includes a plurality of gate wirings, a plurality of source wirings, a plurality of pixel portions, an electrical short pad part and a short element. The gate wirings are formed on the display substrate and are formed from a gate metallic layer. The source wirings are formed from a source metallic layer to be electrically insulated from the gate wirings, the source wirings crossing the gate wirings. The pixel portions are formed in areas defined by the gate wirings and the source wirings and form a display area. The electrical short pad part is formed in a peripheral area surrounding the display area and formed from at least one of the gate metallic layers and the source metallic layer receiving a common voltage. The short element contacts the electrical short pad part and has electric conductivity. The electrical short pad part includes a first metallic layer and a second metallic layer in sequence, and the second metallic layer has greater ionization energy than the first metallic layer.

In another aspect of the present invention, a method for manufacturing a display substrate include forming a gate pattern including gate wirings extended from a peripheral area toward a display area, a common voltage wiring formed in the peripheral area and an electrical short pad part electrically connected to the common voltage wiring on the display substrate having the display area and the peripheral area forming a gate insulation layer having a first hole corresponding to the electrical short pad part on the display substrate having the gate pattern, forming a source pattern including source wirings crossing the gate wirings on the gate insulation layer, forming a passivation layer having a second hole corresponding to the first hole on the gate insulation layer having the source pattern, and forming a short element making direct contact with the electrical short pad part through the first and second holes. The gate pattern includes a first metallic layer, and the first metallic layer having greater ionization energy than aluminum-neodymium (AlNd) alloy.

In still another aspect of the present invention, a liquid crystal display apparatus includes a first substrate, a second substrate, liquid crystal layer and a short element. The first substrate includes a display area having a plurality of pixel portions and a peripheral area surrounding the display area. The electrical short pad part is formed in the peripheral area to receive a common voltage. The second substrate faces the first substrate and includes a common electrode having a transparent electrode layer facing the first substrate. The liquid crystal layer is disposed between the first substrate and the second substrate corresponding to the display area. The short element includes a first end portion making contact with the electrical short pad part and a second end portion making contact with the common electrode to electrically connect the electrical short pad part to the common electrode. The electrical short pad part includes a first metallic layer, and the first metallic layer has greater ionization energy than aluminum-neodymium (AlNd) alloy.

According to the above, an application of static electricity generated in a manufacturing process of a display substrate is prevented, so that defects of the display substrate may decrease.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating an LCD apparatus in accordance with a first embodiment of the present invention;

FIG. 2 is a cross-sectional view illustrating a pixel portion, a first short point, a first pad and a second pad of the LCD apparatus of FIG. 1;

FIGS. 3 to 9 are cross-sectional views illustrating a method for manufacturing the display substrate of FIG. 2;

FIG. 10 is a cross-sectional view illustrating a display substrate in accordance with a second embodiment of the present invention; and

FIG. 11 is a cross-sectional view illustrating a display substrate in accordance with a third embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

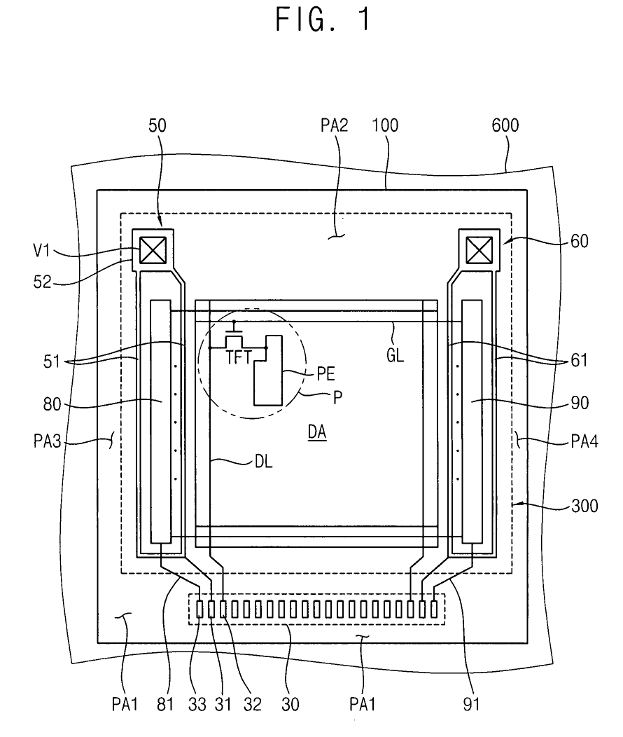

FIG. 1 is a plan view illustrating an LCD apparatus 600 in accordance with a first embodiment of the present invention.

Referring to FIG. 1, an LCD apparatus 600 includes a display substrate 100, an opposing substrate 300 and a liquid crystal layer (not shown) disposed between the display substrate 100 and the opposing substrate 300.

The display substrate 100 includes a first transparent substrate. A display area DA, a first peripheral area PA1, a second peripheral area PA2, a third peripheral area PA3 and a fourth peripheral area PA4 surrounding the display area DA are defined on the first transparent substrate. The first, second, third and fourth peripheral areas PA1, PA2, PA3 and PA4 surround the display area DA.

A plurality of gate wirings GL, a plurality of source wirings DL, and a plurality of pixel portions P defined by the gate wirings GL and the source wirings DL are formed in the display area DA. A thin film transistor TFT electrically connected to each of the gate wirings GL and each of the source wirings DL and a pixel electrode PE electrically connected to the thin film transistor TFT are formed in each of the pixel portions P. A storage capacitor is formed in each of the pixel portions P.

A pad part 30 having a plurality of pads 31, 32 and 33 is formed in the first peripheral area PA1. The pad part 30 is electrically connected to a driving chip providing a driving signal to the source wirings DL to drive the pixel portions P.

The pad part 30 includes a first pad 31 electrically connected to end portions of a first common voltage wiring 51 and a second common voltage wiring 61, a second pad 32 electrically connected to an end portion of the source wiring DL, and a third pad 33 electrically connected to end portions of a first driving signal input wiring 81 and a second driving signal input wiring 91. The first, second and third pads 31, 32 and 33 may be formed from substantially the same metallic layer as the gate wiring GL or the source wiring DL. For example, the second pad 32 may be formed from substantially the same metallic layer as the source wiring DL. In FIG. 1, the first, second and third pad 31, 32 and 33, respectively, are formed together in the first peripheral area PA1. Alternatively, the first, second and third pad 31, 32 and 33 may be formed respectively in different peripheral areas.

A first short point 50 and a second short point 60 are formed in the second peripheral area PA2.

The first and second short points 50 and 60 are electrically connected to a common electrode layer (not shown) of the opposing substrate 300 facing the display substrate 100, and transmit a common voltage Vcom to the common electrode layer of the opposite substrate 300.

A first common voltage wiring 51 and a first gate circuit part 80 are formed in the third peripheral area PA3. The first common voltage wiring 51 is electrically connected to the first short point 50 and the storage common electrode (not shown) of the pixel portion P and transmits the common voltage Vcom to the first short point 50 and the storage common electrode.

The first gate circuit part 80 is electrically connected to the first gate driving signal input wiring 81, and outputs gate signals into gate wirings of a first group among the gate wirings GL, in sequence. For example, the first group may be odd-numbered gate wirings.

A second common voltage wiring 61 and a second gate circuit part 90 are formed in the fourth peripheral area PA4. The second common voltage wiring 61 is electrically connected to the second short point 60 and the storage common electrode of the pixel portion P, and transmits the common voltage Vcom to the second short point 60 and the storage common electrode.

The second gate circuit part 90 is electrically connected to the second gate driving signal input wiring 91, and outputs gate signals into gate wirings of a second group among the gate wirings GL, in sequence. For example, the second group may be even-numbered gate wirings.

The opposing substrate 300 and the liquid crystal layer are described below.

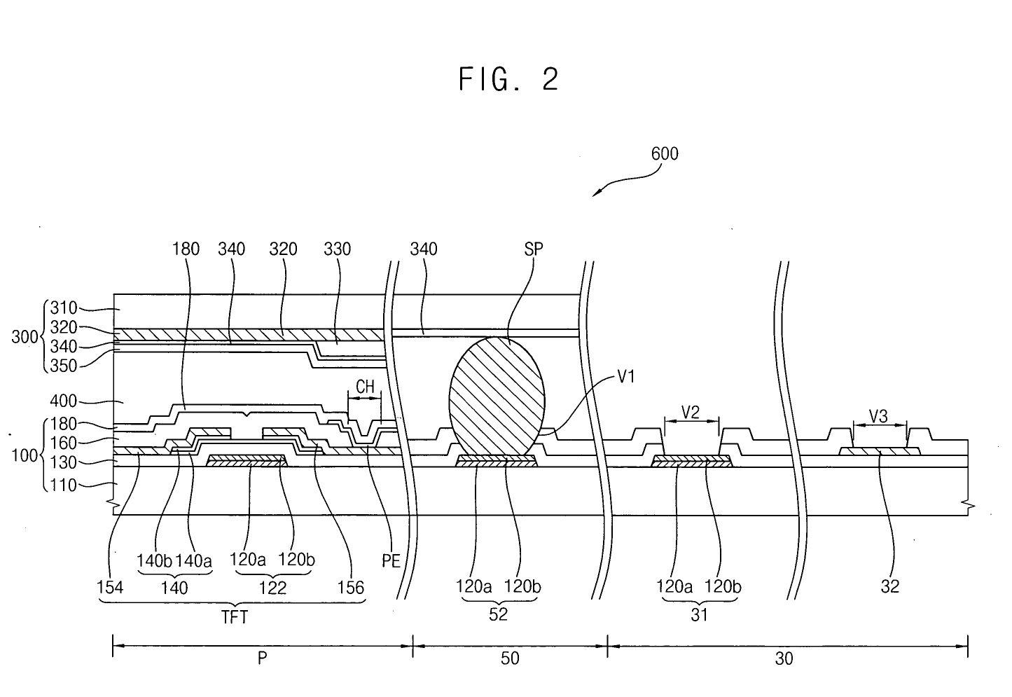

FIG. 2 is a cross-sectional view illustrating a pixel portion, a first short point, a first pad and a second pad of the LCD apparatus of FIG. 1.

Referring to FIGS. 1 and 2, the thin film transistor TFT formed in each of the pixel portions P includes a gate electrode 122, a gate insulation layer 130, a channel layer 140, a source electrode 154 and a drain electrode 156. The gate electrode 122 is extended from the gate wiring GL. A gate pattern having the gate wiring GL, the gate electrode 122, the first and second common voltage wiring 51 and 61 and the first pad 31 is formed by patterning substantially the same metallic layer.

The gate pattern may be formed from a single metallic layer, or may be formed from at least two layers having different physical characteristics.

For example, when the gate pattern is formed from a double layer structure having a first metallic layer 120a and a second metallic layer 120b deposited on the first metallic layer 120a, the first metallic layer 120a is formed from a low-resistance metal in order to function as an electric passage which is a main function of a wiring.

The second metallic layer 120b is formed from a metal having greater ionization energy than the first metallic layer 120a. Ionization tendency is decreased, as ionization energy of a metal is increased. Thus, corrosion resistance of a metallic layer is increased. Accordingly, the second metallic layer 120b formed on the first metallic layer 120a prevents the first metallic layer 120a from corrosion.

For example, the gate pattern may include the first metallic layer 120a having aluminum-neodymium (AlNd) alloy and the second metallic layer 120b having molybdenum (Mo) deposited on the first metallic layer 120a. Alternatively, the gate pattern may include the first metallic layer 120a having aluminum-neodymium (AlNd) alloy and the second metallic layer 120b having chrome (Cr) deposited on the first metallic layer 120a. When the second metallic layer 120b includes chrome (Cr), a surface protective layer may be formed on a surface of the second metallic layer 120b. For example, the surface protective layer may include a chromium nitride layer at a thickness of about 500 Å, and protect chrome from oxidation in the air.

When the gate pattern is formed from a single layer having aluminum-neodymium (AlNd) alloy which is a low-resistant material, defects such as hillock in a high temperature may deteriorate a reliability of wirings, and the gate pattern having worse corrosion resistance than the second metallic layer 120b may be corroded more easily by corrosive chemicals. Accordingly, when the gate pattern is formed from the single layer, the gate pattern preferably may be formed from substantially the same material as the second metallic layer 120b.

A structure having the first metallic layer 120a and the second metallic layer 120b mentioned above in sequence is illustrated as a gate pattern in the present embodiment.

The gate insulation layer 130 may be formed at a front surface of a first transparent substrate 110 having the gate pattern. The gate insulation layer 130, for example, may include a silicon nitride layer (SiNx) or a silicon oxide layer (SiOx), and may be formed by plasma enhanced chemical vapor deposition.

The channel layer 140 is formed on the gate insulation layer 130 to overlap with the gate electrode 122. The channel layer 140, for example, may include an active layer 140a having amorphous silicon (a-Si:H) and an ohmic contact layer 140b implanted by n+ ions at a high concentration (n+a-Si).

The source electrode 154 extends from the source wiring DL, and partially overlapped with the channel layer 140. The drain electrode 156 separated from the source electrode 154, and partially overlaps with the channel layer 140.

The ohmic contact layer 140b of the channel layer 140 is removed in a separate part between the source electrode 154 and the drain electrode 156. Accordingly, the active layer 140a is exposed in the separate part between the source electrode 154 and the drain electrode 156.

When a voltage is applied to the gate electrode 122, a conductive channel is formed in the channel layer 140. When the voltage is not applied to the gate electrode 122, the channel is not formed in the channel layer 140. Accordingly, when a gate driving signal is applied to the gate electrode 122, a source driving signal provided from the source wiring DL is applied to the drain electrode 156 through the channel layer 140.

A third metallic layer is patterned to form a source pattern having the source wiring DL, a second pad 32 on an end portion of the source wiring DL, a source electrode 154 and a drain electrode 156. The third metallic layer has greater ionization energy than the first metallic layer 120a. For example, an ionization energy difference between the third metallic layer and a pixel electrode PE is small. The third metallic layer includes a metallic material having better corrosion resistance than aluminum-neodymium alloy to prevent damage by a physical impact or corrosion by chemicals during a process for manufacturing a display substrate. The ionization energy difference between the third metallic layer and the pixel electrode PE may be smaller than an ionization energy difference between aluminum-neodymium alloy and the pixel electrode PE.

The drain electrode 156 contacts the pixel electrode PE through a contact hole CH which will be mentioned later. The drain electrode 156 is formed from the third metallic layer, and the ionization energy difference between the third metallic layer and pixel electrode PE is small, so that galvanic corrosion is decreased.

For example, the third metallic layer may include a metallic layer having molybdenum or chrome. When the third metallic layer includes a pure chrome layer exposed to the air, chrome and oxygen react with each other, so that a chromium oxide layer is formed. The chromium oxide layer increases a contact resistance with the pixel electrode PE. A surface protective layer having chrome nitride may be formed on the pure chrome layer to prevent forming the chrome oxide layer. The pixel electrode PE and the pure chrome layer may be contacted directly with each other by removing the surface protective layer in the contact hole.

A passivation layer 160 is formed on the first transparent substrate 110 having the thin film transistor TFT. The passivation layer 160, for example, may include a silicon nitride layer or a silicon oxide layer, and may be formed by plasma enhanced chemical vapor deposition.

A contact hole CH is formed in the passivation layer 160, and exposes a portion of the drain electrode 156.

The pixel electrode PE is formed on the passivation layer 160 corresponding to each of the pixel portions P. The pixel electrode PE is contacted with the drain electrode 156 of the thin film transistor through the contact hole CH, and receives the source driving signal from the drain electrode 156. The pixel electrode PE includes a transparent conductive material. Examples of the transparent conductive material that can be used for the pixel electrode PE include indium tin oxide material (ITO), indium zinc oxide material (IZO), etc.

The pixel electrode PE includes the second metallic layer 120b of the gate pattern and a material having etching selectivity with the source pattern.

When the second metallic layer 120b and the source pattern include chrome, the pixel electrode PE includes indium tin oxide having etching selectivity with chrome.

Moreover, when the second metallic layer 120b and the source pattern include molybdenum, the pixel electrode PE includes indium zinc oxide or amorphous indium tin oxide having etching selectivity with molybdenum.

A first alignment layer 180 is formed in the pixel electrode corresponding to the display area DA. The first alignment layer 180 may be formed from an organic alignment layer or an inorganic alignment layer, and may be formed at a constant thickness all-around the display area DA. A surface texture of the first alignment layer 180 is adjusted to arrange liquid crystal molecules of the liquid crystal layer 400.

The first short point 50 includes an electrically conductive short pad 52 and a contact sphere SP.

The electrical short pad 52 is electrically connected to the first common voltage wiring 51 and formed in the second peripheral area PA2. The electrical short pad 52 is formed from substantially the same gate pattern as the first common voltage wiring 51. The gate insulation layer 130 and the passivation layer 160 are formed on the electrical short pad 52. A first via hole V1 is formed on the gate insulation layer 130 and the passivation layer 160 corresponding to the electrical short pad 52.

The electrical short pad 52 is formed from the gate pattern, so that the second metallic layer 120b is exposed through the first via hole V1. The second metallic layer 120b includes a metallic material having greater ionization energy than the first metallic layer 120a to prevent the first metallic layer 120a from corrosion. Accordingly, an extra cover electrode for preventing the second metallic layer 120b from corrosion is not necessary. Therefore, a cover electrode formed from substantially the same layer as the pixel electrode PE on the passivation layer 160 corresponding to the first via hole V1 may be omitted. Accordingly, when static electricity is generated in a process for manufacturing a display substrate, an application of the static electricity to an inside of the display substrate through a cover electrode is prevented. For example, the static electricity may be generated during an alignment rubbing process. When the electrical short pad part is formed from a single metallic layer having substantially the same material as the second metallic layer 120b, the cover electrode mentioned above may also be omitted.

The contact sphere SP is formed on the first via hole V1. The contact sphere SP includes a conductive material. For example, the contact sphere SP may include silver paste. The contact sphere SP makes direct contact with the electrical short pad 52 through the first via hole V1, and receives the common voltage Vcom from the first common voltage wiring 51. The contact sphere SP is formed at substantially the same thickness as a cell gap of the LCD apparatus 600, and an end portion of the contact sphere SP is contacted with a common electrode layer 340 formed in the opposite substrate 300. Accordingly, the common voltage Vcom is applied to the common electrode layer 340 through the contact sphere SP.

The second short point 60 is also formed from substantially the same structure as the first short point 50.

The first pad 31 is formed from the gate pattern and connected to an end portion of each of the first and second gate driving signal input wirings 81 and 91 and/or an end portion of each of the first and second common voltage wirings 51 and 61.

When the first and second gate circuit parts 80 and 90 are not formed in the display substrate 100, the third pad 33 is formed at an end portion of each of the gate wirings GL, and the third gate pad 33 is electrically connected to a gate driving chip.

The gate insulation layer 130 and the passivation layer 160 are formed on the first pad 31. A second via hole V2 exposing the first pad 31 is formed in the gate insulation layer 130 and the passivation layer 160. The first pad 31 is formed from the gate pattern, and the second metallic layer 120b is exposed through the second via hole V2. The second metallic layer 120b includes a metallic material having greater ionization energy than the first metallic layer 120a to prevent the gate pattern from corrosion. Accordingly, an extra cover electrode formed on the second via hole V2 for preventing the first metallic layer 120a from corrosion is not necessary. When the gate pattern is formed from a single metallic layer having substantially the same material as the second metallic layer 120b, the cover electrode mentioned above may also be omitted.

The second pad 32 is formed from substantially the same source pattern as the source wiring DL, so that the second pad 32 is formed from the third metallic layer. As mentioned above, the third metallic layer having greater ionization energy than aluminum-neodymium (AlNd) alloy, so that an extra cover electrode formed on the third via hole V3 for preventing the second pad 32 from corrosion is omitted. The third metallic layer may include molybdenum, chrome and so on.

The opposing substrate 300 may be formed at a smaller area than the display substrate 100, and may be combined with the display substrate 100. The liquid crystal layer 400 is interposed between the display substrate 100 and the opposite substrate 300. The opposite substrate 300 covers the display area DA and the first and second short point 50 and 60. The opposite substrate 300 includes a second transparent substrate 310. A black matrix 320, a color filter layer 330, a common electrode layer 340 and a second alignment layer 350 may be formed on an opposite surface to the display substrate 100 of the opposite substrate 300, in sequence.

The black matrix 320 is formed corresponding to the gate wiring GL, the source wiring DL and the thin film transistor TFT formed in the display area DA. The black matrix 320 blocks leaking light generated from an area of the display substrate 100 except the pixel electrode PE. The color filter layer 330 includes a plurality of color filters opposite to the pixel electrodes PE formed in the display substrate 100.

The common electrode 340 includes substantially the same material as the pixel electrode PE and may be opposite to the opposite substrate 300.

The second alignment layer 350 is formed on the common electrode layer 340 corresponding to the display area DA. A surface texture of the second alignment layer 350 is adjusted to arrange liquid crystal molecules of the liquid crystal layer 400.

The liquid crystal layer 400 is injected only into the display area DA by sealing elements formed on boundaries between the display area DA and the peripheral areas PA1, PA2, PA3 and PA4. The liquid crystal layer 400 is arranged by an electronic field formed between the pixel electrode PE of the display substrate 100 and the common electrode layer 340 of the opposite substrate 300, and transmits light.

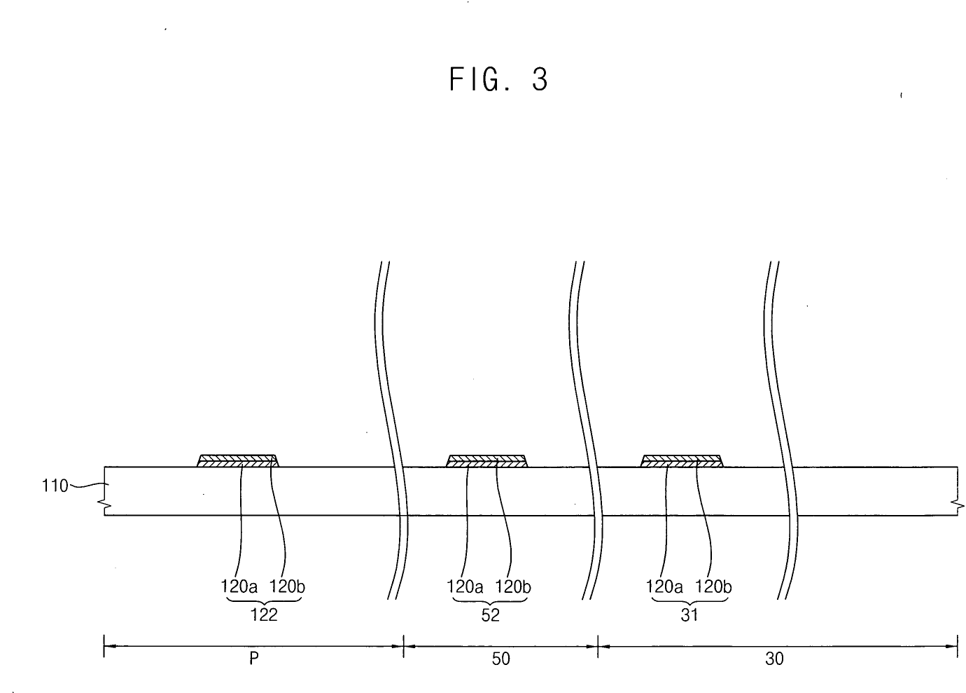

FIGS. 3 to 9 are cross-sectional views illustrating a method for manufacturing the display substrate of FIG. 2.

Referring to FIGS. 2 and 3, a first metallic layer 120a is formed on a first transparent substrate 110. For example, the first metallic layer 120a may include aluminum-neodymium alloy.

A second metallic layer 120b including a metallic material having greater ionization energy than the first metallic layer 120a is formed on the first metallic layer 120a. The second metallic layer 120b, for example, may include molybdenum. The second metallic layer 120b may have a double layered structure including a pure chrome layer and a surface protective layer having a pure chrome layer on the pure chrome layer. The first and second metallic layers 120a and 120b are formed by sputtering process.

When the second metallic layer 120b has the pure chrome layer and the surface protective layer having chrome nitride, the surface protective layer may be formed with a pure chrome layer by providing nitrogen gas in a sputtering chamber in a latter period of a sputtering process forming the pure chrome layer, in situ. The chrome nitride layer may be formed at a thickness of about 500 Å. The chrome nitride layer will not be illustrated because the chrome nitride layer is a thin film formed on a surface of the pure chrome layer.

The first metallic layer 120a and the second metallic layer 120b are simultaneously patterned by a photolithography process using an exposure mask to form a gate pattern including a gate wiring GL, a gate electrode 122 electrically connected to the gate wiring GL, a first common voltage wiring 51, a second common voltage wiring 61, an electrical short pad 52 and a first pad 31.

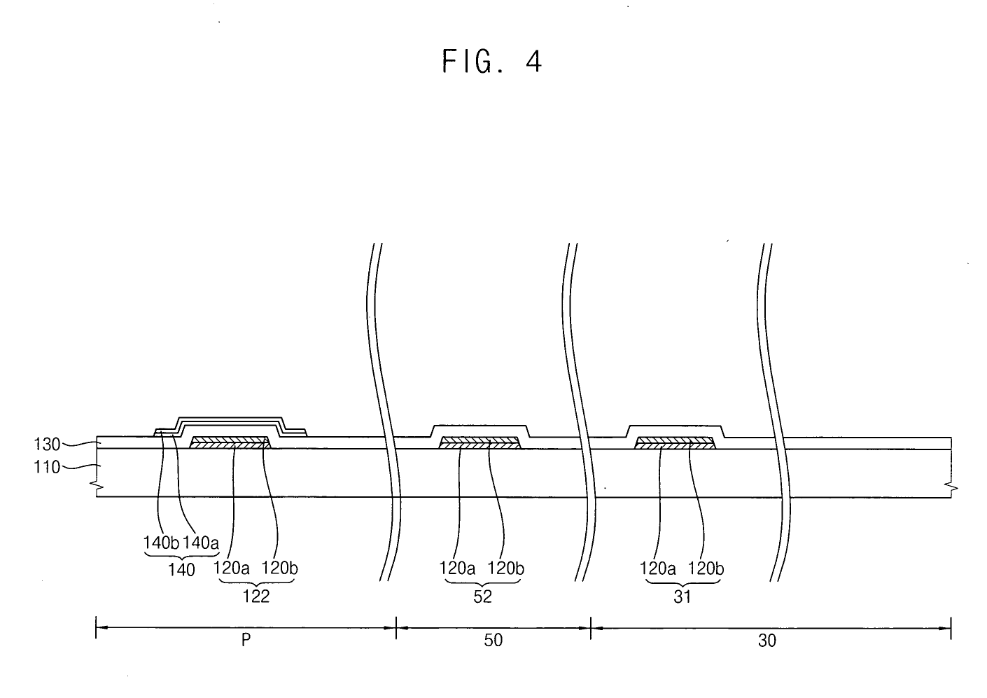

Referring to FIG. 4, a gate insulation layer 130 is formed on a first transparent substrate 110 having the gate pattern. The gate insulation layer 130, for example, may include silicon nitride layer (SiNx) or silicon oxide layer (SiOx), and may be formed by plasma enhanced chemical vapor deposition (PECVD).

An active layer 140a having amorphous silicon (a-Si:H) and an ohmic contact layer 140b implanted by n+ ion at a high concentration (n+a-Si) are deposited on the base substrate 110 having the gate insulation layer 130, in sequence. The active layer 140a and the ohmic contact layer 140b may be formed by plasma enhanced chemical vapor deposition (PECVD).

The active layer 140a and the ohmic contact layer 140b are simultaneously patterned by a photolithography process to form a channel layer 140 which overlaps with the gate electrode 122 on the gate insulation layer 130.

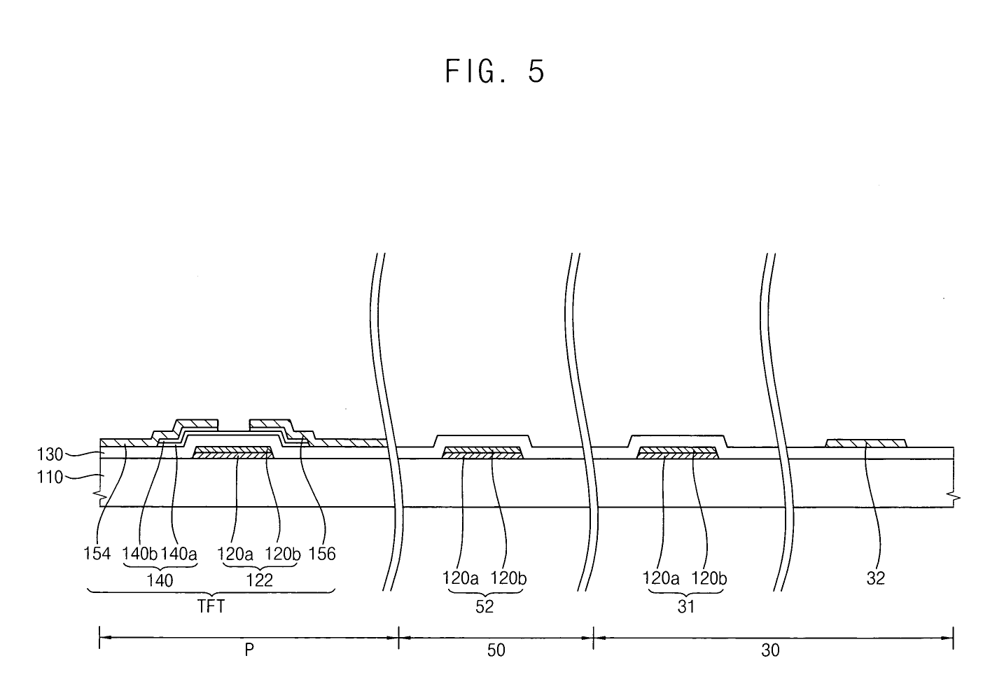

Referring to FIG. 5, a third metallic layer is formed on the base substrate 110 having the channel layer 140 by a sputtering process. The third metallic layer, for example, may include a metallic material having greater ionization energy than aluminum-neodymium alloy. An ionization energy difference between the third metallic layer and a pixel electrode is smaller than an ionization energy difference between an aluminum-neodymium layer and the pixel electrode. Accordingly, galvanic corrosion caused by connecting a pixel electrode with the aluminum-neodymium alloy having a greater ionization energy difference from the pixel electrode is decreased. For example, the third metallic layer may include molybdenum. The third metallic layer may have the pure chrome layer and the surface protective layer having the chrome nitride layer on the pure chrome layer.

The third metallic layer is patterned by a photolithography process to form a source wiring DL and a source pattern including the source wiring DL, a second pad 32, a source electrode 154 and a drain electrode 156.

The source electrode 154 is electrically connected to the source wiring DL and partially overlaps with the channel layer 140. The drain electrode 156 is separated from the source electrode 154 and overlaps with the channel layer 140. The second pad 32 is formed in an end portion of the source wiring DL.

The ohmic contact layer 140b exposed between the drain electrode 156 and the source electrode 154 is etched by the source electrode 154 and the drain electrode 156 as an etching mask. Accordingly, the active layer 140a is exposed between the drain electrode 156 and the source electrode 154.

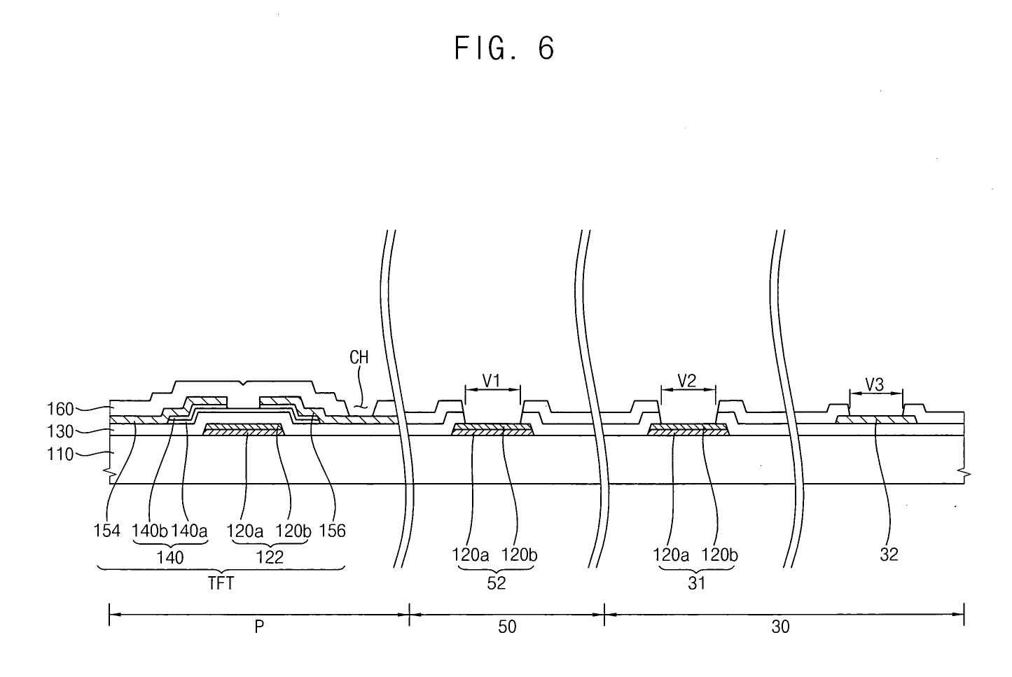

Referring to FIG. 6, a passivation layer 160 is formed on the gate insulation layer 130 having the source pattern. The passivation layer 160, for example, may include silicon nitride layer (SiNx) or silicon oxide layer (SiOx), and may be formed by plasma enhanced chemical vapor deposition (PECVD). The gate insulation layer 130 and the passivation layer 160 are patterned by a photolithography process using an exposure mask to form a contact hole CH exposing an end portion of the drain electrode 156, a first via hole V1 exposing an electrical short pad 52 in the gate insulation layer 130 and the passivation layer 160 corresponding to the electrical short pad 52, a second via hole V2 exposing the first pad 31 in the gate insulation layer 130 and passivation layer 160 corresponding to the first pad 31 and a third via hole V3 exposing the second pad 32 is formed in the passivation layer 160 corresponding to the second pad 32. The gate insulation layer 130 and the passivation layer 160, for example, may be etched by a dry etching process.

The electrical short pad 52 and the first pad 31 is formed from the gate pattern, and the second metallic layer 120b is exposed through the first via hole V1 and the second via hole V2. The second metallic layer 120b includes a metallic material having greater ionization energy than the first metallic layer 120a to prevent the first metallic layer 120a, and the electrical short pad 52 exposed through the first and second via holes V1 and V2 and the first pad 31 from corrosion. Accordingly, an extra cover electrode for preventing the electrical short pad 52 on the first and second via holes V1 and V2 and the first pad 31 from corrosion may be omitted. Moreover, the second pad 32 includes a third metallic layer having greater ionization energy than the first metallic layer 120a, so that an extra cover electrode formed on the third via hole V3 for preventing the second pad 32 from corrosion may be omitted.

When the second metallic layer. 120b of the gate pattern and the source pattern may have as a structure in which a surface protective layer having chrome nitride is formed on pure chrome, the chrome nitride layer is also etched in an etching process of the passivation layer 160 and the gate insulation layer 130. Accordingly, the pure chrome layer is exposed in the contact hole CH and the first, second and third via holes V1, V2 and V3.

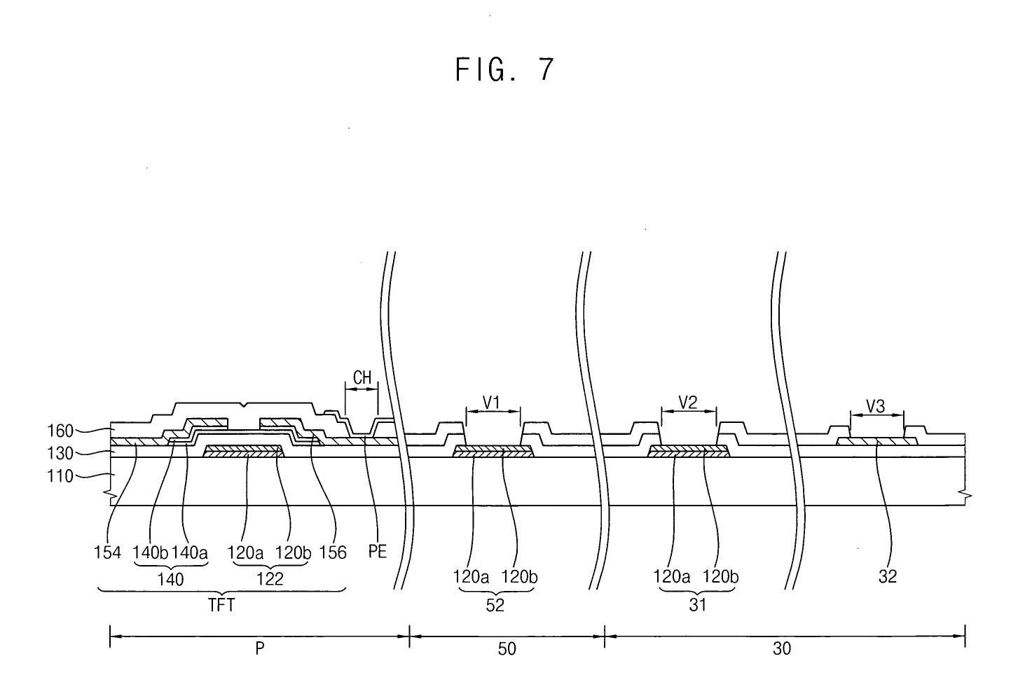

Referring to FIG. 7, a transparent conductive material is deposited on a front surface of a first transparent substrate 110 of the passivation layer 160. The transparent conductive material, for example, may include indium tin oxide, indium zinc oxide, amorphous indium tin oxide and so on, and may be deposited by a sputtering process. The transparent conductive material has an etching selectivity from the second metallic layer 120b of the gate pattern and the source pattern.

When the second and third metallic layers include chrome, the transparent conductive material includes indium tin oxide having an etching selectivity from the chrome.

Moreover, when the second and third metallic layers include molybdenum, the transparent conductive material includes indium zinc oxide or amorphous indium tin oxide having an etching selectivity from the molybdenum.

The transparent conductive material is patterned by a photolithography process to form a pixel electrode PE corresponding to each pixel portions P. The pixel electrode PE is contacted with the drain electrode 156 through the contact hole CH.

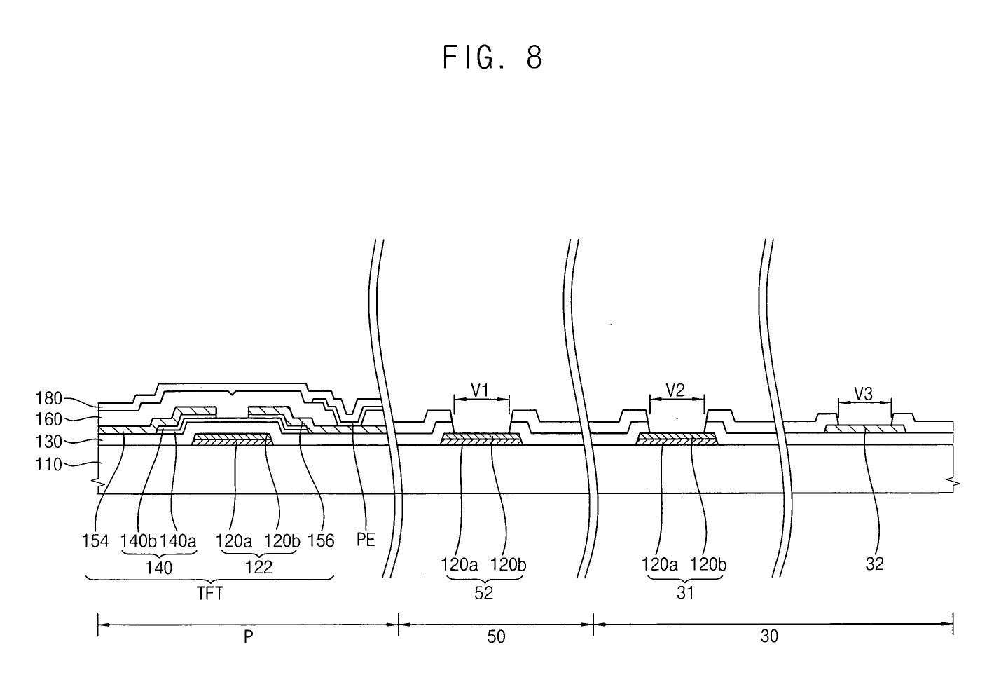

Referring to FIG. 8, a first alignment layer 180 is formed on a first transparent substrate 110 having the pixel electrode PE corresponding to the display area DA. The first alignment layer 180 may include an organic alignment layer or an inorganic alignment layer. A surface of the first alignment layer 180 is rubbed using a rubbing cloth so that the surface texture of the first alignment layer 180 is adjusted to align the liquid crystal molecules of the liquid crystal layer 400.

Static electricity may be generated in the rubbing process by the rubbing cloth including fibers. A conductive material or an extra cover electrode is not formed on the electrical short pad part formed in the peripheral areas PA1, PA2, PA3 and PA4 and the passivation layer 160 corresponding to the pad part 30. Accordingly, an application of the static electricity through the electrical short pad 52 and the pad part 30 is prevented. Short defects or wiring defects of the display substrate 100 caused by the application of the static electricity are prevented, so that a reliability of the display substrate 110 may improve.

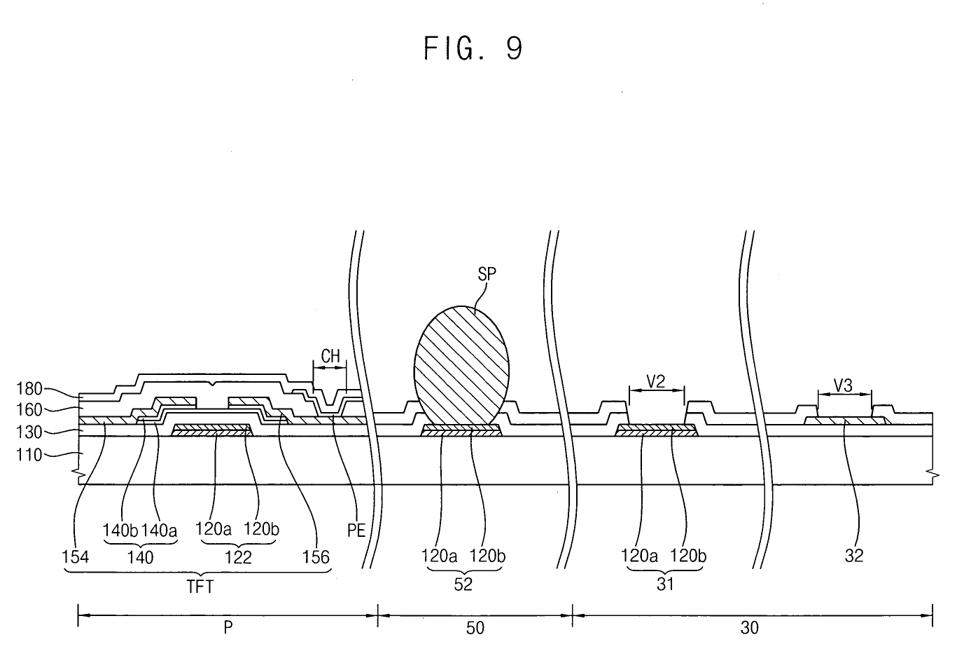

Referring to FIG. 9, a contact sphere SP including a conductive material is formed on the first via hole V1 exposing the electrical short pad 52. The contact sphere SP, for example, may include silver paste, and may be formed at a greater thickness than a cell gap of the LCD apparatus 600. The contact sphere SP having a greater thickness than the cell gap of the LCD apparatus 600 is compressed in an assembly process of the display substrate 100 and the opposing substrate 300 so that the compressed contact sphere SP has substantially the same height as the cell gap of the LCD apparatus 600.

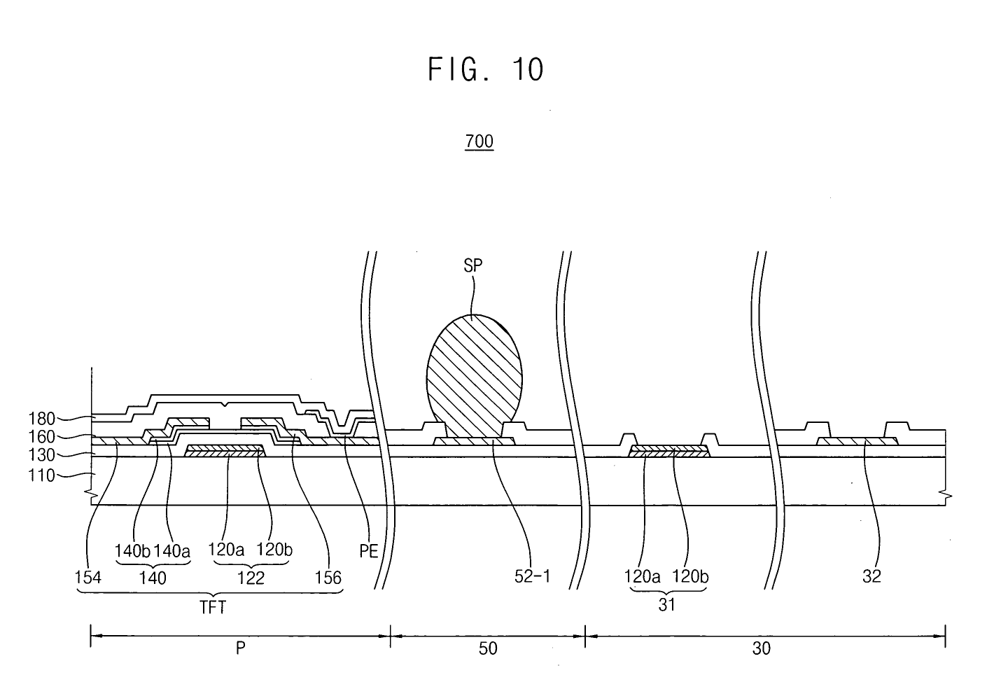

FIG. 10 is a cross-sectional view illustrating a display substrate in accordance with a second embodiment of the present invention.

The display substrate 700 of the present embodiment of the present invention has a number of structures which are common to the first embodiment. Thus, the same reference numerals are used to refer to the same or like parts as those described in the first embodiment and any further repetitive explanation concerning the above elements are not provided.

Referring to FIGS. 1, 2 and 10, the first and second common voltage wirings 51 and 61 and the electrical short pad 52 may be formed from the gate pattern in FIGS. 1 and 2. However, the first and second common voltage wirings 51 and 61 and the electrical short pad 52-1 as shown in FIG. 10, may be formed from substantially the same source pattern as the source wiring DL from which source electrode 154 extends. The source pattern includes a third metallic layer having greater ionization energy than the first metallic layer 120a, so that an extra cover electrode for preventing the electrical short pad 52 from corrosion may be omitted. The second metallic layer 120b of the gate pattern also has greater ionization energy than the first metallic layer 120a. Accordingly, in FIGS. 1, 2 and 10, an application of static electricity and a corrosion of the electrical short pad part are prevented.

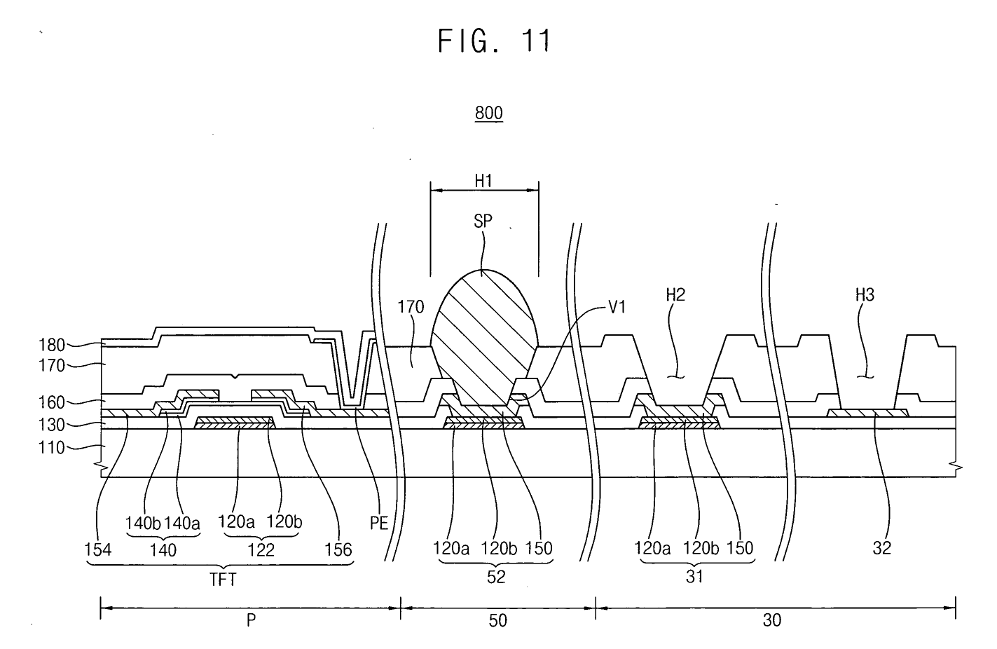

FIG. 11 is a cross-sectional view illustrating a display substrate in accordance with a third embodiment of the present invention.

The display substrate 800 of the present embodiment of the present invention has a number of structures which are common to the first embodiment. Thus, the same reference numerals are used to refer to the same or like parts as those described in the first embodiment and any further repetitive explanation concerning the above elements are not provided.

Referring to FIGS. 2 and 11, electrical short pad 52 of a display substrate 800 of the third embodiment of the present invention includes a first metallic layer 120a of a gate pattern, a second metallic layer 120b of the gate pattern and a third metallic layer 150 of a source pattern. The first, second and third metallic layers 120a, 120b and 150 are formed on a first transparent substrate 110, in sequence. The third metallic layer 150 contacts the second metallic layer 120b through a first via hole V1 formed in the gate insulation layer 130. A passivation layer 160 having a hole corresponding to the first via hole V1 is formed on the third metallic layer 150.

The first pad 31 may also have as substantially the same deposited structure as the electrical short pad 52.

Moreover, the display substrate 800 of the third embodiment includes an organic insulation layer 170 between a passivation layer 160 and a pixel electrode PE. The organic insulation layer 170 is formed at a front surface of the first transparent substrate 110 including a display area DA and peripheral areas PA1, PA2, PA3 and PA4 to planarize the display substrate 800. A first hole H1, a second hole H2 and a third hole H3 corresponding to an electrical short pad 52, a first pad 31 and a second pad 32, respectively, are formed in the organic insulation layer 170, respectively. Although the organic insulation layer 170 is formed on the display substrate 800, the organic insulation layer 170 is formed only in a display area DA. In addition, the organic insulation layer 170 may not be formed in the peripheral areas PA1, PA2, PA3 and PA4. However, in the third embodiment, the organic insulation layer 170 is also formed in the peripheral areas PA1, PA2, PA3 and PA4, so that a peripheral area exposing a metallic layer surrounding the electrical short pad 52 is effectively insulated. Accordingly, an application of static electricity into an inside of the display substrate 800 through the electrical short pad 52 is prevented, so that defects of the display substrate 800 caused by the application of the static electricity may decrease.

The organic insulation layer 170 may also be formed on the display substrates 100 and 700 of FIGS. 2 and 10.

According to the above, in accordance with the present invention, a metallic layer having great ionization energy and excellent corrosive resistance is used as a wiring material, so that corrosion of a pad part exposing a surface of a display substrate is decreased. Accordingly, an extra cover electrode formed on a passivation layer for preventing corrosion caused by an exposure of the pad part may be omitted, so that an application of static electricity generated in a manufacturing process into an inside of the display substrate through the cover electrode is prevented. Therefore, display substrate defects such as a wiring defect, a thin film transistor damaging and so on may decrease.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display substrate comprising:
a plurality of gate wirings formed from a gate metallic layer on a base, the gate wirings extending in a first direction;
a plurality of source wirings formed from a source metallic layer, the source wirings extending in a second, different direction and being insulated from the gate wirings;
a plurality of pixel portions formed in areas defined by the gate wirings and the source wirings, the pixel portions forming a display area;
an electrically conductive short pad formed in a peripheral area surrounding the display area, the short pad being formed from at least one of the gate metallic layer and the source metallic layer, the electrically conductive short pad including a first metallic layer and a second metallic layer positioned on the first metallic layer, the second metallic layer having greater ionization energy than the first metallic layer; and
an electrically conductive short element contacting the short pad.

2. The display substrate of claim 1, wherein one or more of the pixel portions comprises:
a thin film transistor electrically connected to at least one of the gate wirings and to at least one of the source wirings; and
a pixel electrode electrically connected to the thin film transistor, and wherein the second metallic layer has etching selectivity different than the pixel electrode.

3. The display substrate of claim 2, wherein an ionization energy difference between the second metallic layer and the pixel electrode is smaller than an ionization energy difference between the first metallic layer and the pixel electrode.

4. A display substrate comprising:
a plurality of gate wirings formed from a gate metallic layer on a base, the gate wirings extending in a first direction;
a plurality of source wirings formed from a source metallic layer, the source wirings extending in a second, different direction and being insulated from the gate wirings;
a plurality of pixel portions formed in areas defined by the gate wirings and the source wirings, the pixel portions forming a display area;
an electrically conductive short pad formed in a peripheral area surrounding the display area, the short pad being formed from at least one of the gate metallic layer and the source metallic layer,
the electrically conductive short pad including a first metallic layer having greater ionization energy than aluminum-neodymium (AlNd) alloy; and
an electrically conductive short element contacting the short pad.

5. The display substrate of claim 4, wherein one or more of the pixel portions comprises:
a thin film transistor electrically connected to at least one of the gate wirings and to at least one of the source wirings; and
a pixel electrode electrically connected to the thin film transistor, and wherein the first metallic layer has etching selectivity different than the pixel electrode.

6. The display substrate of claim 5, wherein an ionization energy difference between the first metallic layer and the pixel electrode is smaller than an ionization energy difference between the aluminum-neodymium (AlNd) alloy and the pixel electrode.

7. The display substrate of claim 4, wherein the first metallic layer comprises molybdenum.

8. The display substrate of claim 4, wherein the first metallic layer comprises chrome.

9. The display substrate of claim 4, wherein the electrically conductive short pad is formed from the gate metallic layer.

10. The display substrate of claim 9, wherein the gate metallic layer comprises a first metallic layer and a second metallic layer under the first metallic layer, and the second metallic layer comprises aluminum-neodymium (AlNd) alloy.

11. The display substrate of claim 4, wherein the electrically conductive short pad is formed from the source metallic layer.

12. The display substrate of claim 4, wherein the electrically conductive short pad comprises a first portion formed from the gate metallic layer and a second portion formed from the source metallic layer, and the second portion of the electrically conductive short pad is formed on the first portion.

13. The display substrate of claim 4, wherein the pixel portions are formed at a front surface of the display substrate and comprise an organic insulation layer having a hole which is aligned with the electrically conductive short pad.

14. A method of manufacturing a display substrate, comprising:
forming a gate pattern including gate wirings extending from a peripheral area toward a display area, a common voltage wiring formed in the peripheral area and an electrical short pad electrically connected to the common voltage wiring on the display substrate having the display area and the peripheral area, the gate pattern including a first metallic layer having greater ionization energy than aluminum-neodymium (AlNd) alloy;
forming a gate insulation layer having a first hole corresponding to the electrical short pad on the display substrate having the gate pattern;
forming a source pattern including source wirings crossing the gate wirings on the gate insulation layer;
forming a passivation layer having a second hole corresponding to the first hole on the gate insulation layer having the source pattern; and
forming a short element making direct contact with the electrical short pad through the first and second holes.

15. The method of claim 14, wherein the gate pattern further comprises a second metallic layer including aluminum-neodymium (AlNd) alloy under the first metallic layer.

16. The method of claim 14, further comprising forming an organic insulation layer having a third hole corresponding to the second hole on the passivation layer.

17. A method of manufacturing a display substrate, comprising:
forming a gate pattern including gate wirings extending from a peripheral area toward a display area on the display substrate having the display area and the peripheral area;
forming a gate insulation layer on the display substrate having the gate pattern;
forming a source pattern including source wirings crossing the gate wirings, a common voltage wiring formed in the peripheral area and a first electrical short pad electrically connected to the common voltage wiring on the gate insulation layer, the source pattern including a metallic layer having greater ionization energy than aluminum-neodymium (AlNd) alloy;
forming a passivation layer having a first hole corresponding to the first electrical short pad on the gate insulation layer having the source pattern; and
forming a short element making direct contact with the first electrical short pad through the first hole.

18. The method of claim 17, wherein the gate pattern comprises a second electrical short pad corresponding to the first electrical short pad.

19. The method of claim 18, wherein a second hold corresponding to the second electrical short pad is formed in the gate insulation layer.

20. A liquid crystal display apparatus comprising:
a first substrate including a display area having a plurality of pixel portions and a peripheral area surrounding the display area;
an electrical short pad formed in the peripheral area, the electrical short pad including a first metallic layer having greater ionization energy than aluminum-neodymium (AlNd) alloy;
a second substrate facing the first substrate and including a common electrode having a transparent electrode layer facing the first substrate;
a liquid crystal layer disposed between the first substrate and the second substrate corresponding to the display area; and
a short element including a first end portion making contact with the electrical short pad part and a second end portion making contact with the common electrode to electrically connect the electrical short pad part to the common electrode.
